(19) United States
(12) Patent Application Publication
(10) Pub. No.: US 2024/0299227 A1
(43) Pub. Date: Sep. 12, 2024

(54) AUXILIARY CLEANING DEVICE FOR DISABLED PERSON

(71) Applicant: BEIJING HUASHANG HUIZHI HOME ELDERLY SERVICE CO., LTD., Beijing (CN)

(72) Inventors: Jianping Wu, Beijing (CN); Ruixiang Jiang, Beijing (CN); Jianguo Jiang, Beijing (CN); Yonggang Han, Beijing (CN); Haifu Du, Beijing (CN); Dafeng Han, Beijing (CN); Shuzhi Shen, Beijing (CN); Diangang Wang, Beijing (CN); Wanquan Wang, Beijing (CN); Yuqiang Guo, Beijing (CN); Dahua Han, Beijing (CN); Shuyin LI, Beijing (CN); Jie Han, Beijing (CN)

(21) Appl. No.: 18/576,738

(22) PCT Filed: Mar. 30, 2023
(86) PCT No.: PCT/CN2023/085180

§ 371 Date: Jan. 4, 2024

(30) Foreign Application Priority Data
Mar. 31, 2022 (CN) 202210337108.4

(51) Int. Cl. A61G 7/10; A47K 7/02; A47K 7/08; A61G 9/02

(52) U.S. Cl. CPC A61G 7/109; A47K 7/02; A47K 7/08; A61G 9/02; A61G 2200/327

(57) ABSTRACT

An auxiliary cleaning device for a disabled person, comprising a movable support (1), a leg lifting device (2), and a cleaning device (3). The distances between a cleaning mechanism (33) and a part to be cleaned of a user in a first direction, a second direction, and a third direction are automatically adjusted, such that the cleaning mechanism (33) is driven by a mechanical arm mechanism (32) to move to a designated position near said part, so as to perform an operation such as cleaning of said part.

### CROSS-REFERENCE TO RELATED APPLICATIONS

This application claims the priority of Chinese patent application CN 202210337108.4 filed on Mar. 31, 2022, the entirety of which is incorporated herein by reference.

### FIELD OF THE INVENTION

The present disclosure relates to the technical field of nursing instruments, and in particular, to an auxiliary cleaning device for a disabled person.

### BACKGROUND OF THE INVENTION

The problem of sanitary treatment of feces and urine of a disabled person is always a difficult issue. For the disabled person, a caregiver is required to assist in cleaning and meanwhile give mental comfort, so that the disabled person is clean physically and feels at ease psychologically; and for the caregiver, greater physical strength is required for operations, and thus a device that helps to solve the problem of sanitary treatment of feces and urine is needed, so that the caregiver can easily provide care and the disabled person can be more comfortable.

### SUMMARY OF THE INVENTION

The present disclosure provides an auxiliary cleaning device for a disabled person, which helps to solve the problem of sanitary treatment of feces and urine of the disabled person.

The present disclosure provides an auxiliary cleaning device for a disabled person, which includes:
a movable support;
a leg lifting device, which may be disposed on the support, and is configured to raise or lower legs of a user; and
a cleaning device, which includes a lift mechanism disposed at the bottom of the support and a mechanical arm mechanism connected to the lift mechanism, a cleaning mechanism being disposed on the mechanical arm mechanism;
the lift mechanism actuates the mechanical arm mechanism to ascend or descend, so as to adjust a distance between the cleaning mechanism and the part to be cleaned of the user in a first direction; and
the mechanical arm mechanism is configured to be extendable or foldable, so as to adjust a distance between the cleaning mechanism and the part to be cleaned of the user in a second direction and a distance between the cleaning mechanism and the part to be cleaned of the user in a third direction.

In some embodiments, the mechanical arm mechanism includes a first actuation rod and a first mechanical arm, and a first end of the first actuation rod is connected to a first end of the first mechanical arm; and when the mechanical arm mechanism is fully folded, the first actuation rod is parallel to the first mechanical arm;
a first sliding rail and a second sliding rail extending in the first direction are respectively disposed on the support, a second end of the first actuation rod being slidably disposed on the first sliding rail, the first end of the first mechanical arm is slidably disposed on the second sliding rail; and
the first actuation rod is configured to actuate the first mechanical arm to rotate with an axis of the second sliding rail as a rotation axis.

In some embodiments, the mechanical arm mechanism further includes a second mechanical arm and a second actuation rod, a cleaning mechanism being disposed at a first end of the second mechanical arm, a second end of the second mechanical arm being connected to a second end of the first mechanical arm, a first end of the second actuation rod being rotatably connected to the first end of the first mechanical arm, a second end of the second actuation rod being rotatably connected to the first mechanical arm and the second mechanical arm via a connection mechanism; and
the second actuation rod is configured to actuate the second mechanical arm to rotate with a connection point of the second mechanical arm and the first mechanical arm as a pivot point, so as to allow the cleaning mechanism to change a position thereof.

In some embodiments, a first oblique arm, which is inclined towards the second mechanical arm, is disposed at the second end of the first mechanical arm, a second oblique arm, which is inclined towards the first mechanical arm, being disposed at the second end of the second mechanical arm, an end of the first oblique arm being rotatably connected to an end of the second oblique arm, a connection point of the end of the first oblique arm and the end of the second oblique arm being a pivot point of the second mechanical arm.

In some embodiments, the connection mechanism includes a first arc-shaped connecting rod, which is rotatably connected to the first oblique arm, and a second arc-shaped connecting rod, which is rotatably connected to the second oblique arm, both the first arc-shaped connecting rod and the second arc-shaped connecting rod being rotatably connected to the second end of the second actuation rod.

In some embodiments, the lift mechanism includes an actuation plate, which is disposed below the mechanical arm mechanism, and a third actuation rod connected to the actuation plate; and
the actuation plate is connected to the second end of the first actuation rod and the first end of the first mechanical arm respectively, and the third actuation rod is configured to allow the actuation plate to move in the first direction, so as to actuate the mechanical arm mechanism to move in the first direction.

In some embodiments, an elastic energy storage element is further sleeved on the first sliding rail, one end of the elastic energy storage element abutting against the second end of the first actuation rod, the other end of the elastic energy storage element being fixed on the support.

In some embodiments, the leg lifting device includes a leg fixator and a pulley mechanism which is fixed on the support, and the leg fixator is connected to the pulley mechanism; and
the leg fixator includes two recesses, and the recesses are configured to receive the legs of the user; bladders are disposed at sidewalls of the recesses, and when the bladders are inflated, the legs of the user are fixed in the recesses by extrusion; and when the bladders are deflated, the legs of the user are released.

In some embodiments, the auxiliary cleaning device further includes a first positioning means and a second positioning means disposed on the leg fixator;
the first positioning means is signalized to the third actuation rod, and when the first positioning means determines that the mechanical arm mechanism is located at a target position in the first direction, the third actuation rod is allowed to stop moving; and
the second positioning means is signalized to the first actuation rod and the second actuation rod respectively, and when the second positioning means determines that the cleaning mechanism is located at a target position in the second direction and at a target position in the third direction, the first actuation rod and the second actuation rod are allowed to stop moving.

In some embodiments, the cleaning mechanism includes a cleaning brush, a cleaning nozzle and a warm wind nozzle located above the cleaning brush, and the cleaning nozzle and the warm wind nozzle are respectively connected to a liquid storage tank and an air blower located at the bottom of the support.

Compared with existing technologies, the present disclosure has the following advantages. By automatically adjusting a distance between a cleaning mechanism and a part of a user to be cleaned in a first direction, in a second direction, and in a third direction, the cleaning mechanism is actuated by a mechanical arm mechanism to move to a designated position near the part to be cleaned so as to carry out operations such as cleaning on the part to be cleaned. Therefore, by a combined action of a leg lifting device, a lift mechanism, and the mechanical arm mechanism, the labour intensity of the caregiver can be alleviated, and the disabled person can also receive careful sanitary nursing.

### BRIEF DESCRIPTION OF THE DRAWINGS

The present disclosure will be described in a more detailed way below based on embodiments and with reference to the accompanying drawings.

FIG. 1 is a front view of an auxiliary cleaning device for a disabled person according to an embodiment of the present disclosure, a bed and a user being not shown;

FIG. 2 is a side view of an auxiliary cleaning device for a disabled person according to an embodiment of the present disclosure, a bed and a user being not shown;

FIG. 3 is a front view of a bed according to an embodiment of the present disclosure;

FIG. 4 is a front view of an auxiliary cleaning device for a disabled person according to an embodiment of the present disclosure, a bed being shown;

FIG. 5 is a front view of an auxiliary cleaning device for a disabled person according to an embodiment of the present disclosure, a bed and a user being shown, legs of the user being in a flat state;

FIG. 6 is a side view of an auxiliary cleaning device for a disabled person according to an embodiment of the present disclosure, a bed being shown;

FIG. 7 is a front view of an auxiliary cleaning device for a disabled person according to an embodiment of the present disclosure, legs of the user being in a raised state;

FIG. 8 is a side view of an auxiliary cleaning device for a disabled person according to an embodiment of the present disclosure, a position of a pulley mechanism being shown when legs of the user being in a raised state;

FIG. 9 is a front view of the auxiliary cleaning device shown in FIG. 1;

FIG. 10 is a schematic view of a structure of a mechanical arm mechanism shown in FIG. 9 in a folded state;

FIG. 11 is a schematic view of a structure of the mechanical arm mechanism shown in FIG. 9, a first mechanical arm being in an unfolded state;

FIG. 12 is a schematic view of a structure of the mechanical arm mechanism shown in FIG. 9, a second mechanical arm being in an unfolded state;

FIG. 13 is a schematic view of a structure of the mechanical arm mechanism shown in FIG. 9 in an unfolded state in use;

FIG. 14 is a top view of a leg fixator shown in FIG. 1;

FIG. 15 is a front view of the leg fixator shown in FIG. 1;

FIG. 16 is a top view of the bed shown in FIG. 3;

FIG. 17 is a front view of an auxiliary cleaning device for a disabled person according to an embodiment of the present disclosure, a view of a first positioning means capturing a first sensing position being shown;

FIG. 18 is an enlarged view at a section I in FIG. 7; and

FIG. 19 is an enlarged view at a section II in FIG. 7.

### REFERENCE NUMERALS

1-support; 11-first sliding rail; 12-second sliding rail; 13-elastic energy storage element; 14-upper fixation plate; 15-lower fixation plate; 16-holder; 17-rolling wheel; 18-first sensing position; 19-second sensing position;
2-leg lifting device;
21-leg fixator;
211-recess; 212-bladder; 213-hook; 214-mounting plate;
22-pulley mechanism;
221-pulley; 222-pulling rope; 223-motor;
3-cleaning device;
31-lift mechanism;
311-actuation plate; 312-third actuation rod; 313-pushing block;
32-mechanical arm mechanism;
321-first actuation rod; 322-first mechanical arm; 323-second mechanical arm; 324-second actuation rod;
325-first oblique arm; 326-second oblique arm; 327-first arc-shaped connecting rod; 328-second arc-shaped connecting rod; 329-sleeve;
33-cleaning mechanism;
331-cleaning brush; 332-cleaning nozzle; 333-warm wind nozzle; 334-corrugated pipe; 335-water pipe; 336-wind pipe;
34-coupler;
35-collecting means;
351-waterproof cloth; 352-hip cushion; 353-collecting basin; 354-waste discharge pipe;
4-first positioning means; 5-second positioning means;
6-user; 7-bed.

### DETAILED DESCRIPTION OF THE EMBODIMENTS

The present disclosure is further described below with reference to the accompanying drawings.

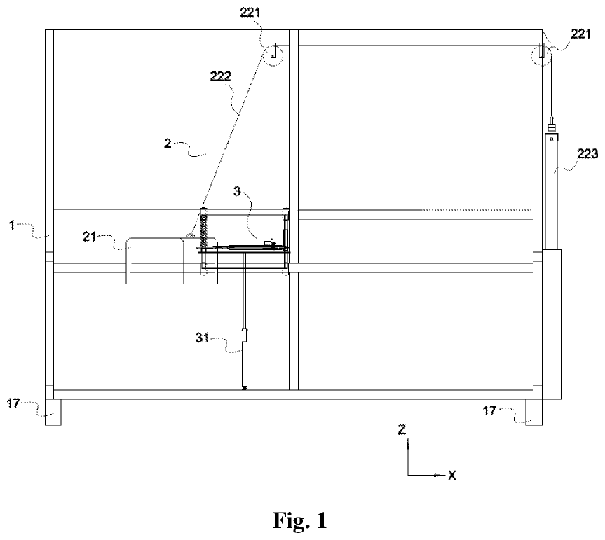

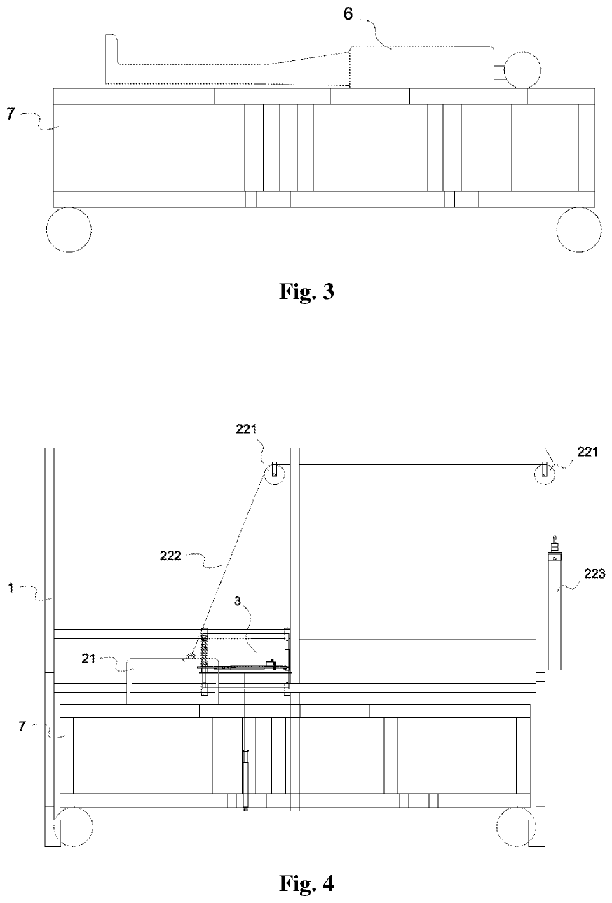

As shown in FIG. 1 to FIG. 4, the present disclosure provides an auxiliary cleaning device for a disabled person, which can provide auxiliary cleaning, such as changing the diaper, carrying out cleaning and drying after defecation and urination, and so on to a person who has lost the self-care ability of daily living. Specifically, the auxiliary cleaning device of the present disclosure includes a movable support 1, a leg lifting device 2, and a cleaning device 3. Alternatively, the auxiliary cleaning device may further include a bed 7 for supporting a user 6. A rolling wheel 17 is disposed at the bottom of the support 1, and one caregiver can easily push the support 1. One side or one end of the support 1 is in an open state, and the support 1 can be pushed in from one end or one side of bed 7 when the support 1 is moved near the bed 7, so that the bed 7 and the user 6 are surrounded in the middle for the convenience of performing operations such as sanitary cleaning on the user 6.

Therefore, it is understandable that the auxiliary cleaning device of the present disclosure may include the bed 7 which is matched with the support 1.

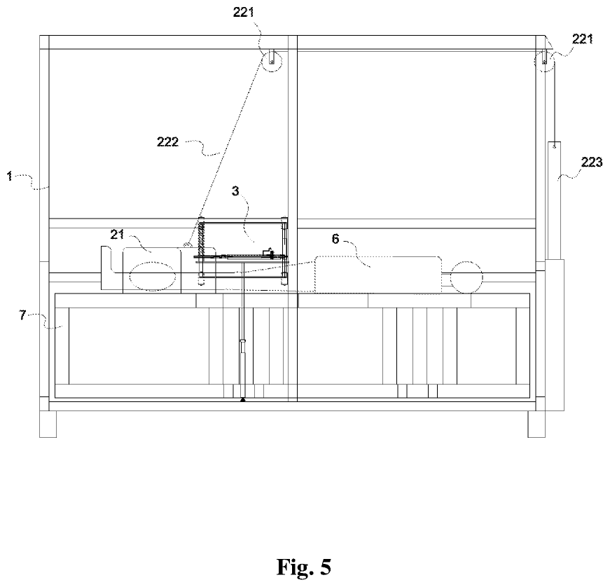

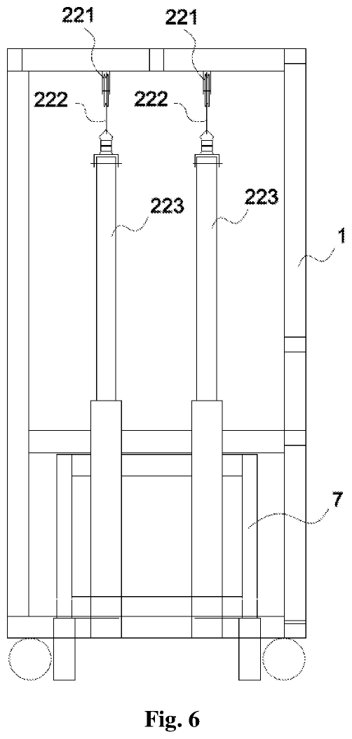

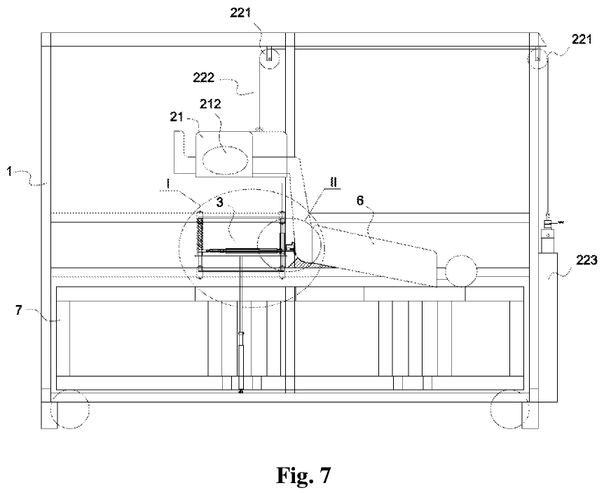

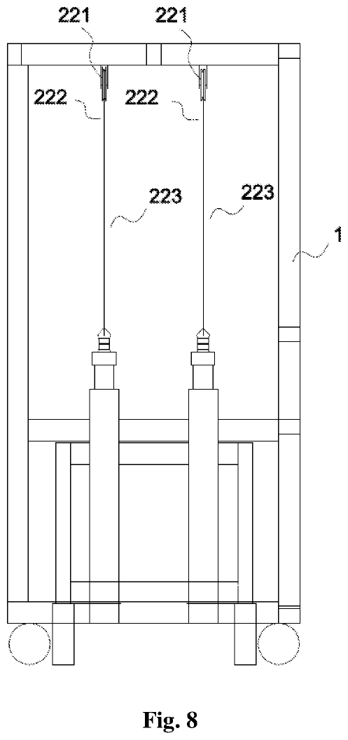

As shown in FIG. 5 to FIG. 8, the leg lifting device 2 may be disposed on the support 1, and the leg lifting device 2 is configured to raise or lower legs of the user 6 (including the hip). The cleaning device 3 is disposed on the support 1, and after the leg lifting device 2 raises the legs of the user 6 (as shown in FIG. 7), the cleaning device 3 may adjust a position between the cleaning device 3 and a part to be cleaned of the user 6, so as to perform sanitary cleaning on the part to be cleaned.

The cleaning device 3 includes a lift mechanism 31 disposed at the bottom of the support 1 and a mechanical arm mechanism 32 connected to the lift mechanism 31, a cleaning mechanism 33 being disposed on the mechanical arm mechanism 32. The lift mechanism 31 actuates the mechanical arm mechanism 32 to ascend or descend, so as to adjust a distance between the cleaning mechanism 33 and the part to be cleaned of the user 6 in a first direction (the Z axis direction shown in FIG. 1); and the mechanical arm mechanism 32 is configured to be extendable or foldable, so as to adjust a distance between the cleaning mechanism 33 and the part to be cleaned of the user 6 in a second direction (the X axis direction shown in FIG. 1) and a distance between the cleaning mechanism 33 and the part to be cleaned of the user 6 in a third direction (the Y axis direction shown in FIG. 1).

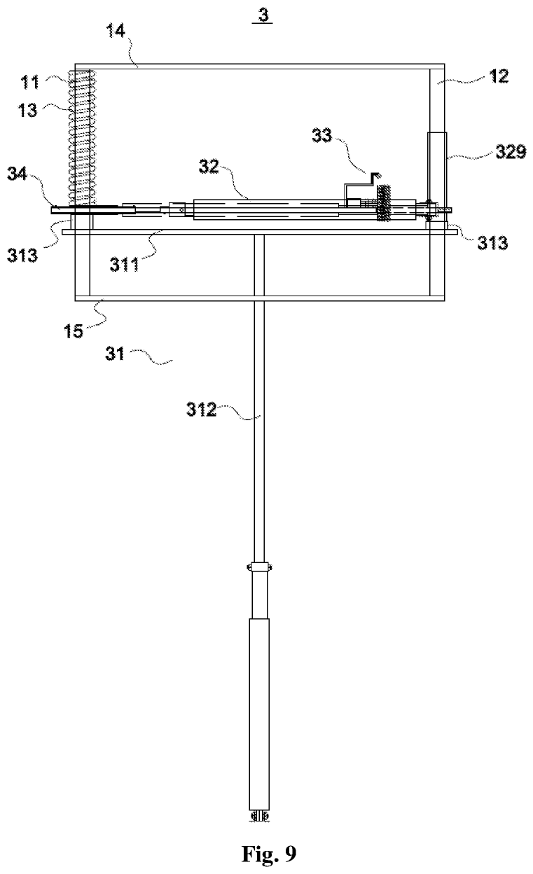

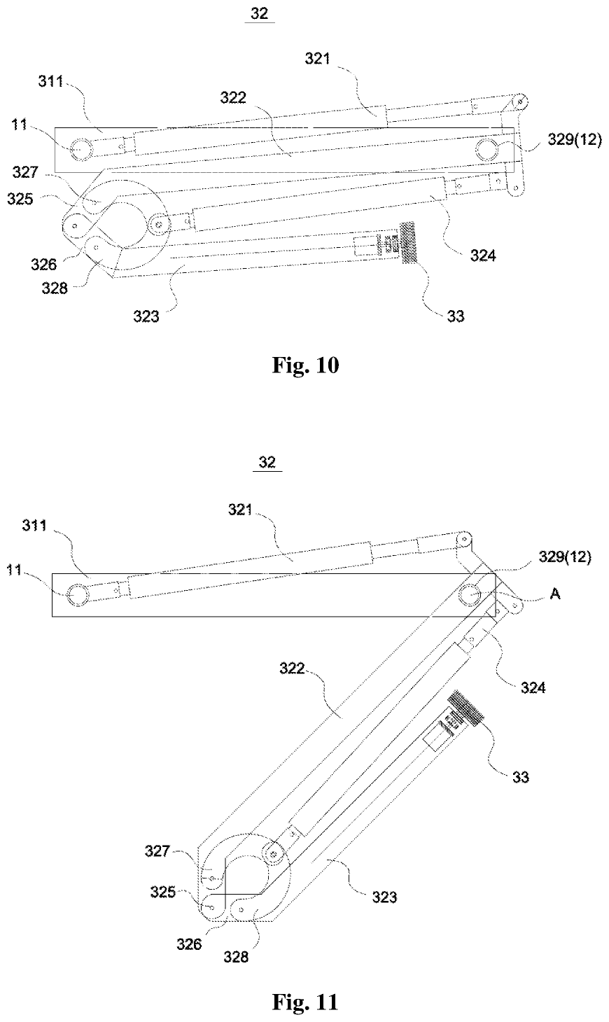

As shown in FIG. 9 to FIG. 13, the mechanical arm mechanism 32 includes a first actuation rod 321 and a first mechanical arm 322, and a first end (i.e., a right end shown in FIG. 10) of the first actuation rod 321 is connected to a first end (i.e., a right end shown in FIG. 10) of the first mechanical arm 322. When the mechanical arm mechanism 32 is fully folded (as shown in FIG. 10), the first actuation rod 321 is roughly parallel to the first mechanical arm 322.

As shown in FIG. 9 and FIG. 10, a first sliding rail 11 and a second sliding rail 12 extending in the first direction are respectively disposed on the support 1. A second end (i.e., a left end shown in FIG. 10) of the first actuation rod 321 is slidably disposed on the first sliding rail 11, and the first end of the first mechanical arm 322 (i.e., the right end shown in FIG. 10) is slidably disposed on the second sliding rail 12. The first actuation rod 321 is configured to actuate the first mechanical arm 322 to rotate with an axis of the second sliding rail 12 (i.e., a pivot point A shown in FIG. 11) as a rotation axis. Therefore, when the first actuation rod 321 is operated an angle between the first actuation rod 321 and the first mechanical arm 322 may be increased or decreased. As shown in FIG. 10, the first actuation rod 321 is parallel to the first mechanical arm 322, and the angle therebetween is minimum. As shown in FIG. 11, when the first actuation rod 321 is operated, the first mechanical arm 322 rotates around the pivot point A counterclockwise, so that the angle between the first actuation rod 321 and the first mechanical arm 322 is increased (i.e., the mechanical arm mechanism 32 is in an unfolded state).

Preferably, the first actuation rod 321 is an electrically actuated push rod or a pneumatically actuated push rod.

More specifically, a coupler 34 is disposed at the second end of the first actuation rod 321, and the coupler 34 is sleeved on the first sliding rail 11, and the first actuation rod 321 and the coupler 34 are slidable on the first sliding rail 11. A sleeve 329 is disposed on the first end of the first mechanical arm 322. The sleeve 329 is sleeved on the second sliding rail 12, and the first mechanical arm 322 and the sleeve 329 are slidable on the second sliding rail 12.

It is understandable that the second end of the first actuation rod 321 may also be slidably connected to the first sliding rail 11 via a sleeve.

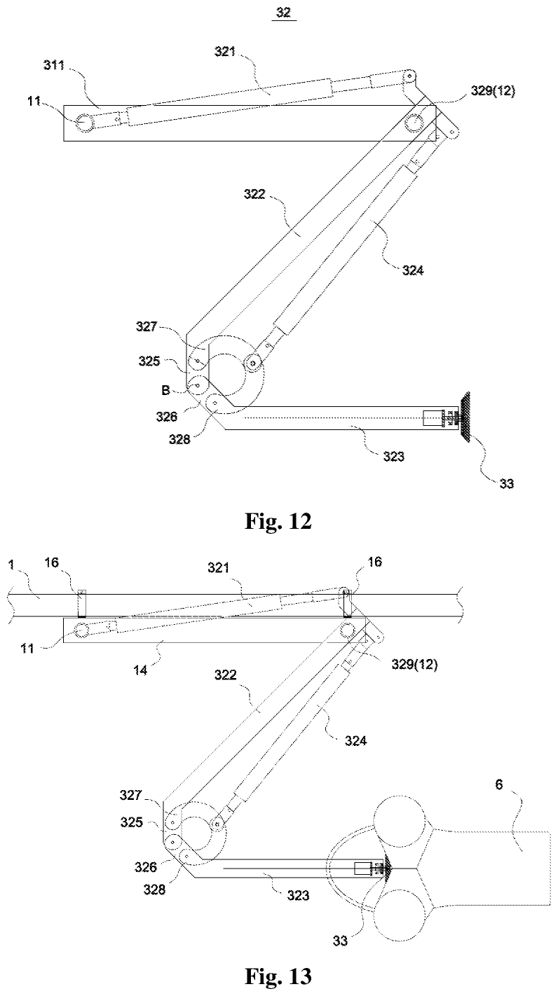

Further, the mechanical arm mechanism 32 may also include a second mechanical arm 323 and a second actuation rod 324. A cleaning mechanism 33 is disposed at a first end (a right end shown in FIG. 12) of the second mechanical arm 323, and a second end (a left end shown in FIG. 12) of the second mechanical arm 323 is connected to a second end (a left end shown in FIG. 12) of the first mechanical arm 322. A first end (a right end shown in FIG. 12) of the second actuation rod 324 is rotatably connected to the first end (a right end shown in FIG. 12) of the first mechanical arm 322, and a second end (a left end shown in FIG. 12) of the second actuation rod 324 is rotatably connected to the first mechanical arm 322 and the second mechanical arm 323 via a connection mechanism.

The second actuation rod 324 is configured to actuate the second mechanical arm 323 to rotate with a connection point of the second mechanical arm 323 and the first mechanical arm 322 as a pivot point (a pivot B shown in FIG. 12), so as to allow the cleaning mechanism 33 to change a position thereof.

As shown in FIG. 11, when the second actuation rod 324 is not operated, the first mechanical arm 322 is roughly parallel to the second mechanical arm 323. As shown in FIG. 12, when the second actuation rod 324 is operated, the second mechanical arm 323 rotates clockwise with a connection point between the second mechanical arm 323 and the first mechanical arm 322 as a pivot point, so that an angle between the second mechanical arm 323 and the first mechanical arm 322 is increased (i.e., the mechanical arm mechanism 32 is in an unfolded state).

Preferably, the second actuation rod 324 is an electrically actuated push rod or a pneumatically actuated push rod.

Further, a first oblique arm 325, which is inclined towards the second mechanical arm 323 (i.e., the first oblique arm 325 is inclined downwards), is disposed at the second end (the left end shown in FIG. 12) of the first mechanical arm 322, and a second oblique arm 326, which is inclined towards the first mechanical arm 322 (i.e., the second oblique arm 326 is inclined upwards), is disposed at the second end of the second mechanical arm 323 (the left end shown in FIG. 12). An end of the first oblique arm 325 is rotatably connected to an end of the second oblique arm 326, and a connection point of the end of the first oblique arm 325 and the end of the second oblique arm 326 is a pivot point of the second mechanical arm 323.

An angle between the first oblique arm 325 and the first mechanical arm 322 may be greater than 90 degrees, for example, 135 degrees. An angle between the second oblique arm 326 and the second mechanical arm 323 may also be greater than 90 degrees, for example, 135 degrees. The first oblique arm 325 is pivotably connected to the second oblique arm 326 at ends thereof.

The angle between the first oblique arm 325 and the first mechanical arm 322 is the same as the angle between the second oblique arm 326 and the second mechanical arm 323, so that in an unfolded state the second mechanical arm 323 are roughly coaxial with the first mechanical arm 322 (as shown in FIG. 10), and extend in the same direction.

The connection mechanism includes a first arc-shaped connecting rod 327, which is rotatably connected to the first oblique arm 325, and a second arc-shaped connecting rod 328, which is rotatably connected to the second oblique arm 326. Both the first arc-shaped connecting rod 327 and the second arc-shaped connecting rod 328 are rotatably connected to the second end (the left end shown in FIG. 12) of the second actuation rod 324.

As shown in FIG. 12, when the second actuation rod 324 is operated, the first arc-shaped connecting rod 327 and the second arc-shaped connecting rod 328 are pushed so that an angle between the first arc-shaped connecting rod 327 and the second arc-shaped connecting rod 328 is increased. Then, the second mechanical arm 323 is allowed to rotate around the pivot point B clockwise, and an angle between the second mechanical arm 323 and the first mechanical arm 322 is increased. The second mechanical arm 323 may rotate by 180 degrees around the pivot point B clockwise. That is, the second mechanical arm 323 is located at an extension line in a reverse direction of the first mechanical arm 322, and the second mechanical arm 323 and the first mechanical arm 322 extend in opposite directions.

As shown in FIG. 13, after the second mechanical arm 323 is adjusted to a proper position, the cleaning mechanism at one end of the second mechanical arm 323 may be aligned with the part to be cleaned of the user, so as to perform a cleaning operation.

As shown in FIG. 9 and FIG. 13, the lift mechanism 31 includes an actuation plate 311, which is disposed below the mechanical arm mechanism 32, and a third actuation rod 312 connected to the actuation plate 311. The actuation plate 311 is connected to the second end (a left end shown in FIG. 13) of the first actuation rod 321 and the first end (a right end shown in FIG. 13) of the first mechanical arm 322 respectively. Specifically, as shown in FIG. 9, a pushing block 313 is disposed on the actuation plate 311, and the pushing block 313 is disposed below the second end of the first actuation rod 321 and below the first end of the first mechanical arm 322 respectively. When the third actuation rod 312 is operated, the actuation plate 311 is actuated to move in the first direction, so as to push the first actuation rod 321 and the first mechanical arm 322 to move in the first direction, thereby adjusting a position of the mechanical arm mechanism 32 in the first direction.

As shown in FIG. 9 and FIG. 13, the first sliding rail 11 and the second sliding rail 12 go through the actuation plate 311, and the first sliding rail 11 and the second sliding rail 12 are disposed in parallel. An upper end of each of the first sliding rail 11 and the second sliding rail 12 is connected to an upper fixation plate 14 on the support 1 via a holder 16, and a lower end of each of the first sliding rail 11 and the second sliding rail 12 is connected to a lower fixation plate 15 on the support 1 via a holder 16.

As shown in FIG. 9, an elastic energy storage element 13 is sleeved on the first sliding rail 11, and the elastic energy storage element 13 may be, for example, a spring element. One end of the elastic energy storage element 13 abuts against the second end of the first actuation rod 321. More specifically, one end of the elastic energy storage element 13 abuts against a coupler 34. The other end of the elastic energy storage element 13 is fixed on the support 1. More specifically, the other end of the elastic energy storage element 13 is fixed on the upper fixation plate 14.

As described above, when the mechanical arm mechanism 32 is in the unfolded state, the first mechanical arm 322 and the second mechanical arm 323 are fully unfolded, and the weight of the first mechanical arm 322 and the second mechanical arm 323 allow the coupler 34 to slide upwards on the first sliding rail 11. Through a downward pressure of the elastic energy storage element 13, the coupler 34 and the mechanical arm mechanism 32 may be kept balanced and stable.

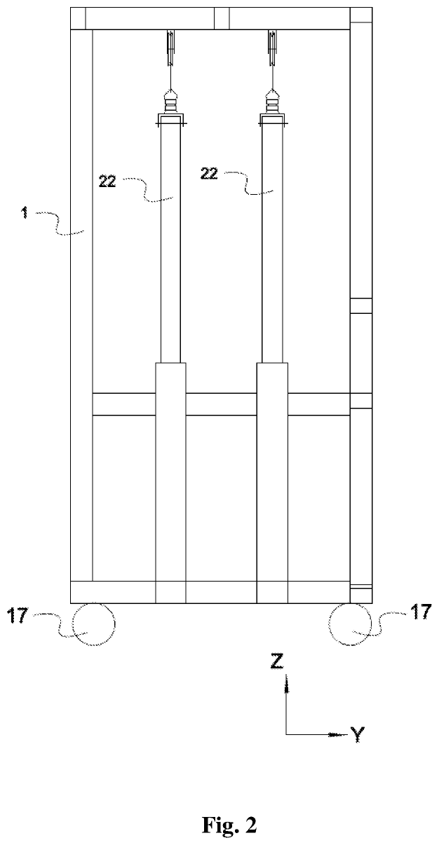

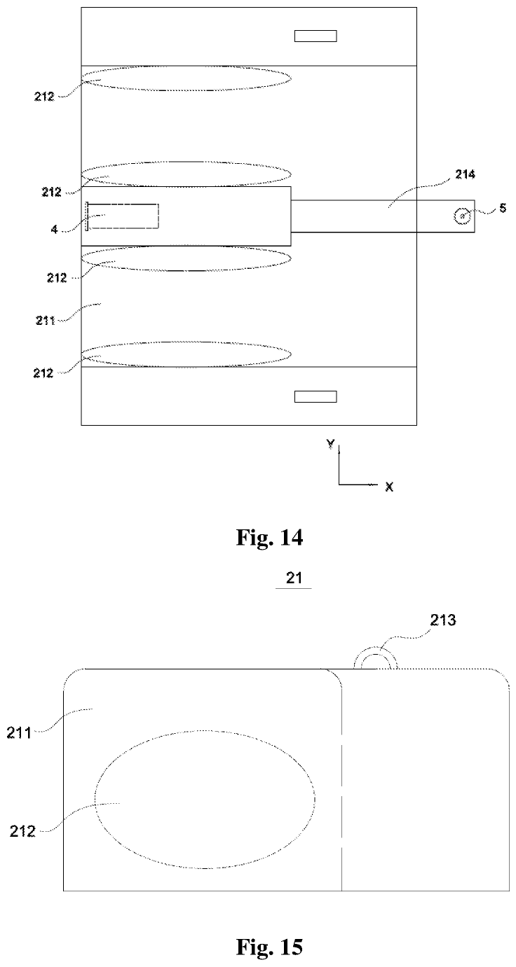

As shown in FIG. 1, FIG. 2, FIG. 5, FIG. 7, FIG. 14, and FIG. 15, the leg lifting device 2 includes a leg fixator 21 and a pulley mechanism 22 which is fixed on the support 1, and the leg fixator 21 is connected to the pulley mechanism 22. The pulley mechanism 22 includes two pulleys 221 (fixed pulleys) disposed at an upper portion of the support 1, a motor 223, and a pulling rope 222. After the pulling rope 222 is connected to the motor 223, the pulling rope 222 passes through two pulleys 221 sequentially and is connected to a hook 213 (as shown in FIG. 15) on the leg fixator 21. By using the motor 223 to actuate the pulling rope 222, the leg fixator 21 may be pulled to ascend or descend, so as to raise legs of the user (as shown in FIG. 7) or lay the legs of the user flat (as shown in FIG. 5).

As shown in FIG. 14, the leg fixator 21 includes two recesses 211, and the recesses 211 are configured to receive the legs of the user 6. The two recesses 211 are disposed symmetrically, and thus is roughly in an epsilon-type structure. Bladders 212 are disposed at sidewalls of the recesses 211. When the calves of the user 6 are placed in the recesses 211, the bladders 212 are inflated, and thus the bladders 212 are expanded. Limited by the space in the recesses 211, the legs of the user 6 are fixed in the recesses 211 by extrusion of the bladder 212; and conversely, when the bladders 212 are deflated, the legs of the user 6 are released.

After the legs of the user 6 are placed in the leg fixator 21, calf parts of the user may be raised, so that the mechanical arm mechanism 32 performs a positioning operation and adjusts a position of mechanical arm mechanism 32 in the first direction, in a second direction, and in a third direction, thereby aligning the cleaning mechanism 33 with the part to be cleaned of the user for carrying out the cleaning operation.

In some alternative embodiments, the positioning operation of the mechanical arm mechanism 32 is performed by means of a first positioning means 4 and a second positioning means 5 disposed on the leg fixator 21.

The first positioning means 4 is signalized to the third actuation rod 312. When the first positioning means 4 determines that the mechanical arm mechanism 32 is located at a target position in the first direction, the third actuation rod 312 is allowed to stop moving.

The second positioning means 5 is signalized to the first actuation rod 321 and the second actuation rod 324 respectively. When the second positioning means 5 determines that the cleaning mechanism 33 is located at a target position in the second direction and at a target position in the third direction, the first actuation rod 321 and the second actuation rod 324 are allowed to stop moving.

Specifically, the first positioning means 4 is an infrared ray optoelectronic switch, and is located at an axis of symmetry between two recesses 211. As shown in FIG. 17, a first sensing position 18 is disposed on the support 1 in the first direction, and the first positioning means 4 may capture the first sensing position 18. The first sensing position 18 is configured to indicate a predetermined position of the mechanical arm mechanism 32 in the first direction. When the pulley mechanism 22 actuates the leg fixator 21 to rise, the third actuation rod 312 actuates the actuation plate 311 and the mechanical arm mechanism 32 to move in the first direction at the same time. In a rising process of the leg fixator 21, when the first positioning means 4 captures the first sensing position 18, the first positioning means 4 sends a signal to the third actuation rod 312. The third actuation rod 312 stops moving, and the mechanical arm mechanism 32 reaches the predetermined position in the first direction.

The second positioning means 5 may also be an infrared ray optoelectronic switch. A mounting plate 214 is disposed between two recesses 211. As shown in FIG. 14, the mounting plate 214 extends beyond the leg fixator 21 in the second direction (the X axis direction), and the second positioning means 5 is disposed at a portion, on the mounting plate 214, which goes beyond the leg fixator 21.

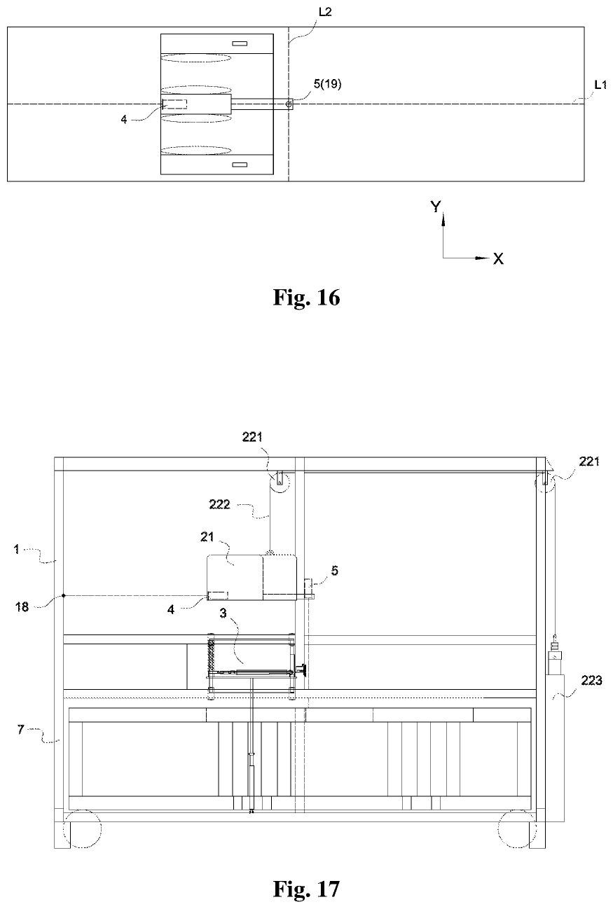

As shown in FIG. 16, an axis of symmetry of the bed 7 in the second direction is L1, and an axis of symmetry of the bed 7 in the third direction is L2. A position where the axis of symmetry L1 and the axis of symmetry L2 intersect is a second sensing position 19. The second positioning means 5 may capture the second sensing position 19, and the second sensing position 19 is configured to indicate a predetermined position of the mechanical arm mechanism 32 in the second direction and a predetermined position of the mechanical arm mechanism 32 in the third direction.

The first actuation rod 321 and the second actuation rod 324 respectively allow the first mechanical arm 322 and the second mechanical arm 323 to adjust the position in the second direction and the position in the third direction. When the second positioning means 5 can capture the second sensing position 19, the second positioning means 5 sends a signal to the first actuation rod 321 and the second actuation rod 324 to allow them to stop moving, and the mechanical arm mechanism 32 reaches the predetermined position in the second direction and the predetermined position in the third direction.

When the position of the mechanical arm mechanism 32 in the first direction, the position thereof in the second direction and the position thereof in the third direction are determined, the mechanical arm mechanism 32 no longer moves; and the cleaning mechanism 33 starts to carry out a cleaning operation. When the cleaning operation is finished, the mechanical arm mechanism 32 moves reversely, and the first actuation rod 321 and the second actuation rod 324 is operated to allow the first mechanical arm 322 and the second mechanical arm 323 to retract, so as to restore the mechanical arm mechanism 32 to a folded state.

In order to suit people with varying heights and weights, a plurality of first sensing positions 18 may be disposed in the first direction, and a plurality of second sensing positions 19, which are offset from the axis of symmetry L1 and the axis of symmetry L2 respectively, may be disposed. When the mechanical arm mechanism 32 is moved, different sensing positions may be selected according to different people, so that the cleaning mechanism 33 can better correspond to the part to be cleaned of the user 6.

It is understandable that a controller (not shown) may be disposed to control movements of the motor 223, the first actuation rod 321, the second actuation rod 324, and the third actuation rod 312, so that the first positioning means 4 and the second positioning means 5 can better feed signals back to the controller.

In some alternative embodiments, the positioning operation of the mechanical arm mechanism 32 may also performed by an image analyzing module and the controller. Specifically, the image analyzing module may identify the part to be cleaned of the user 6, and acquires coordinates of the part to be cleaned by calculation. A trajectory calculation module in the controller acquires a path of the cleaning mechanism 33 by calculation based on a current position of the cleaning mechanism 33 and the coordinates of the part to be cleaned, and select optimal movements of the first actuation rod 321, an optimal action of the second actuation rod 324, and an optimal action of the third actuation rod 312, so that the first actuation rod 321, the second actuation rod 324, and the third actuation rod 312 actuate the cleaning mechanism 33 to a designated position.

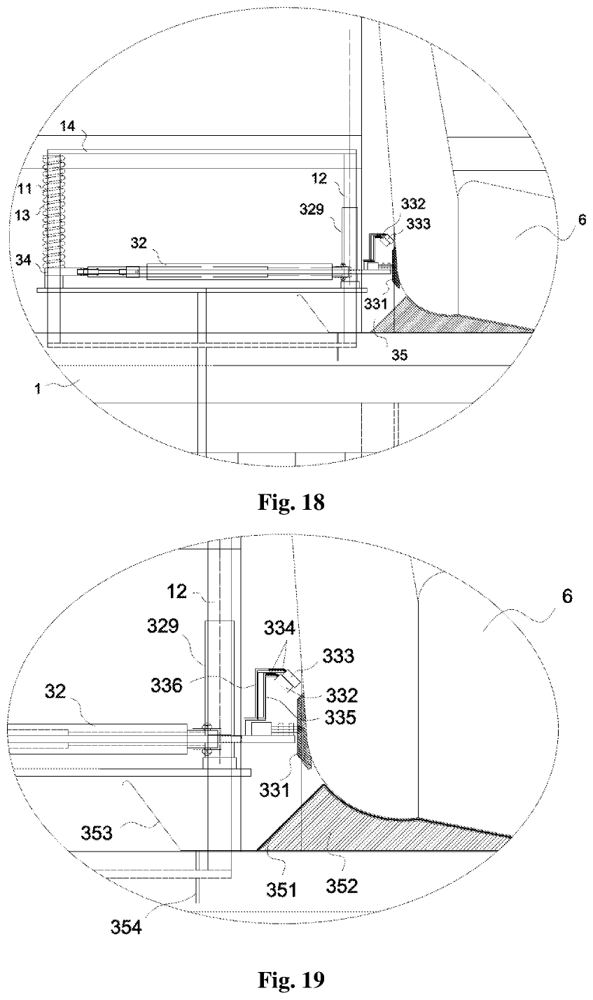

As shown in FIG. 7, FIG. 18, and FIG. 19, the cleaning mechanism 33 includes a cleaning brush 331, a cleaning nozzle 332 and a warm wind nozzle 333 located above the cleaning brush 331. The cleaning nozzle 332 and the warm wind nozzle 333 are respectively connected to a liquid storage tank and an air blower located at the bottom of the support 1.

The cleaning brush 331 may be an electrically brush, and may clean the part to be cleaned of a person who needs care after defecation and urination. By means of the cleaning nozzle 332, clean water may be sprayed to the part to be cleaned for washing, and by means of the warm wind nozzle 333, warm wind blowing and drying may be performed on the part to be cleaned.

As shown in FIG. 19, the cleaning nozzle 332 is connected to a water pipe 335, and the warm wind nozzle 333 is connected to a wind pipe 336. Flexible connections are realized between the cleaning nozzle 332 and the water pipe 335 and between the warm wind nozzle 333 and the wind pipe 336. For example, corrugated pipes 334 are used for connections. By means of the corrugated pipes 334, an angle of the cleaning nozzle 332 and an angle of the warm wind nozzle 333 may be adjusted, so as to adjust a water spraying direction and a wind blowing direction.

The other end of the water pipe 335 and the other end of the wind pipe 336 are respectively connected to the liquid storage tank and the air blower (not shown) at the bottom of the support 1. Water in the liquid storage tank may be pumped into the cleaning nozzle 332 via the water pipe 335, and the air blower can provide warm wind via the wind pipe 336.

Further, as shown in FIG. 18 and FIG. 19, a collecting means 35 is further disposed on the support 1, when the leg fixator 21 raises the legs of the user 6, the collecting means 35 may be placed under the body of the user 6, so as to collect waste water after cleaning.

Optionally, the collecting means 35 includes a collecting basin 353, a hip cushion 352, and a waterproof cloth 351 which covers on the hip cushion 352. The hip cushion 352 is disposed in the collecting basin 353, and a bottom end of the collecting basin 353 is connected to the waste discharge pipe 354.

Preferably, the collecting means 35 includes the collecting basin 353, the hip cushion 352, and the waterproof cloth 351 (as shown in FIG. 19 in bold solid line). The hip cushion 352 is disposed at one side of the collecting basin 353, is disposed under the hip of the user 6, and extends towards the waist, so as to slightly raise the hip of the user, thereby facilitate cleaning. The waterproof cloth 351 covers a portion of the hip cushion 352 and a portion of the collecting basin 353, so that waste water after cleaning is directed to the collecting basin 353 rather than flowing to a position under the body of the user. In addition, the bottom end of the collecting basin 353 is connected to the waste discharge pipe 354. The hip cushion 352 is configured as a taper structure, and an end thereof near the body of the user 6 reduces gradually, so as to facilitate insertion into a position between the body of the user 6 and the bed 7. The waterproof cloth 351 can avoid leaving water or dirt on the bed under the user 6 and can also avoid that wash water flows over the body of the user. By means of the waterproof cloth 351 and the hip cushion 352, it can be ensured that the waste water after cleaning falls into the collecting basin 353.

The waste discharge pipe 354 is detachably connected to a waste water tank at the bottom end of the support 1. After cleaning is finished, the waste discharge pipe 354 may be detached, so as to take out the collecting means 35 from a position under the body of the user 6.

Although the present disclosure has been described in conjunction with preferred embodiments, without departing from the scope of the present disclosure, various improvements can be made to the present disclosure, and equivalents can be used to replace components therein. In particular, as long as there is no structural conflict, various technical features mentioned in various embodiments may be combined in any manner. The present disclosure is not limited to any specific embodiments of the present disclosure, but includes all technical solutions falling into the scope of the claims.

1. An auxiliary cleaning device for a disabled person, wherein the auxiliary cleaning device comprises:
a movable support;
a leg lifting device, which may be disposed on the support, and is configured to raise or lower legs of a user; and
a cleaning device, which comprises a lift mechanism disposed at the bottom of the support and a mechanical arm mechanism connected to the lift mechanism, a cleaning mechanism being disposed on the mechanical arm mechanism,
wherein the lift mechanism actuates the mechanical arm mechanism to ascend or descend, so as to adjust a distance between the cleaning mechanism and the part to be cleaned of the user in a first direction; and
the mechanical arm mechanism is configured to be extendable or foldable, so as to adjust a distance between the cleaning mechanism and the part to be cleaned of the user in a second direction and a distance between the cleaning mechanism and the part to be cleaned of the user in a third direction,
wherein the mechanical arm mechanism comprises a first actuation rod and a first mechanical arm, and a first end of the first actuation rod is connected to a first end of the first mechanical arm; and when the mechanical arm mechanism is fully folded, the first actuation rod is parallel to the first mechanical arm;
a first sliding rail and a second sliding rail extending in the first direction are respectively disposed on the support, a second end of the first actuation rod being slidably disposed on the first sliding rail, the first end of the first mechanical arm is slidably disposed on the second sliding rail; and
the first actuation rod is configured to actuate the first mechanical arm to rotate with an axis of the second sliding rail as a rotation axis.

2. (canceled)

3. The auxiliary cleaning device for a disabled person according to claim 1, wherein the mechanical arm mechanism further comprises a second mechanical arm and a second actuation rod, wherein a cleaning mechanism is disposed at a first end of the second mechanical arm, and a second end of the second mechanical arm is connected to a second end of the first mechanical arm; and a first end of the second actuation rod is rotatably connected to the first end of the first mechanical arm, and a second end of the second actuation rod is rotatably connected to the first mechanical arm and the second mechanical arm via a connection mechanism; and
the second actuation rod is configured to actuate the second mechanical arm to rotate with a connection point of the second mechanical arm and the first mechanical arm as a pivot point, so as to allow the cleaning mechanism to change a position thereof.

4. The auxiliary cleaning device for a disabled person according to claim 3, wherein a first oblique arm, which is inclined towards the second mechanical arm, is disposed at the second end of the first mechanical arm, and a second oblique arm, which is inclined towards the first mechanical arm, is disposed at the second end of the second mechanical arm, wherein an end of the first oblique arm is rotatably connected to an end of the second oblique arm, and a connection point of the end of the first oblique arm and the end of the second oblique arm is a pivot point of the second mechanical arm.

5. The auxiliary cleaning device for a disabled person according to claim 4, wherein the connection mechanism comprises a first arc-shaped connecting rod, which is rotatably connected to the first oblique arm, and a second arc-shaped connecting rod, which is rotatably connected to the second oblique arm, wherein both the first arc-shaped connecting rod and the second arc-shaped connecting rod are rotatably connected to the second end of the second actuation rod.

6. The auxiliary cleaning device for a disabled person according to claim 3, wherein the lift mechanism comprises an actuation plate, which is disposed below the mechanical arm mechanism, and a third actuation rod connected to the actuation plate; and
the actuation plate is connected to the second end of the first actuation rod and the first end of the first mechanical arm respectively, and the third actuation rod is configured to allow the actuation plate to move in the first direction, so as to actuate the mechanical arm mechanism to move in the first direction.

7. The auxiliary cleaning device for a disabled person according to claim 6, wherein an elastic energy storage element is further sleeved on the first sliding rail, wherein one end of the elastic energy storage element abuts against the second end of the first actuation rod, and the other end of the elastic energy storage element is fixed on the support.

8. The auxiliary cleaning device for a disabled person according to claim 6, wherein the leg lifting device comprises a leg fixator and a pulley mechanism which is fixed on the support, and the leg fixator is connected to the pulley mechanism; and
the leg fixator comprises two recesses, and the recesses are configured to receive the legs of the user; bladders are disposed at sidewalls of the recesses, and when the bladders are inflated, the legs of the user are fixed in the recesses by extrusion; and when the bladders are deflated, the legs of the user are released.

9. The auxiliary cleaning device for a disabled person according to claim 8, wherein the auxiliary cleaning device further comprises a first positioning means and a second positioning means disposed on the leg fixator;
the first positioning means is signalized to the third actuation rod, and when the first positioning means determines that the mechanical arm mechanism is located at a target position in the first direction, the third actuation rod is allowed to stop moving; and
the second positioning means is signalized to the first actuation rod and the second actuation rod respectively, and when the second positioning means determines that the cleaning mechanism is located at a target position in the second direction and at a target position in the third direction, the first actuation rod and the second actuation rod are allowed to stop moving.

10. The auxiliary cleaning device for a disabled person according to claim 1, wherein the cleaning mechanism comprises a cleaning brush, a cleaning nozzle and a warm wind nozzle located above the cleaning brush, and the cleaning nozzle and the warm wind nozzle are respectively connected to a liquid storage tank and an air blower located at the bottom of the support.
